(19) United States
(12) Patent Application Publication
(10) Pub. No.: US 2026/0045487 A1
(43) Pub. Date: Feb. 12, 2026

(54) METHOD FOR PRODUCING ELECTRODE COMPOSITE POWDER

(71) Applicants: TOYOTA JIDOSHA KABUSHIKI KAISHA, Toyota-shi (JP); PANASONIC HOLDINGS CORPORATION, Osaka (JP)

(72) Inventors: Masahiro IWASAKI, Nagoya-shi (JP); Kazuki MURAISHI, Toyota-shi (JP); Hiroki YABE, Hirakata-shi (JP); Izuru SASAKI, Kyoto-shi (JP); Keita MIZUNO, Ibaraki-shi (JP); Yusuke NISHIO, Osaka-shi (JP)

(73) Assignees: TOYOTA JIDOSHA KABUSHIKI KAISHA, Toyota-shi (JP); PANASONIC HOLDINGS CORPORATION, Osaka (JP)

(21) Appl. No.: 19/285,531

(22) Filed: Jul. 30, 2025

(30) Foreign Application Priority Data
Aug. 8, 2024 (JP) 2024-132780

(51) Int. Cl. H01M 4/36; H01M 4/04; H01M 4/525; H01M 10/0562

(52) U.S. Cl. CPC H01M 4/366; H01M 4/0407; H01M 4/525; H01M 10/0562; H01M 2300/008

(57) ABSTRACT

A method for producing electrode composite powder according to the present disclosure includes: (a) kneading active material particles and a sulfide solid electrolyte while adding a solvent; and (b) after step (a), kneading the active material particles and the sulfide solid electrolyte without adding a solvent, so as to at least partially deform the sulfide solid electrolyte and coat at least part of a surface of the active material particles with the sulfide solid electrolyte. The kneading speed in step (a) is lower than the kneading speed in step (b). The electrode composite powder includes the active material particles and the sulfide solid electrolyte.

### CROSS-REFERENCE TO RELATED APPLICATION

This application claims priority to Japanese Patent Application No. 2024-132780 filed on Aug. 8, 2024. The disclosure of the above-identified application, including the specification, drawings, and claims, is incorporated by reference herein in its entirety.

### BACKGROUND

### 1. Technical Field

The present disclosure relates to methods for producing electrode composite powder.

### 2. Description of Related Art

Sulfide solid electrolytes exhibit both high ionic conduction properties and relatively good deformability. The sulfide solid electrolytes are suitable for use in bulk-type all-solid-state batteries. However, direct contact between a sulfide solid electrolyte and an active material in an electrode active material layer may accelerate degradation of the sulfide solid electrolyte. Such degradation of the sulfide solid electrolyte may, for example, impair the ionic conduction properties.

In order to reduce direct contact between the sulfide solid electrolyte and the active material, it has been proposed to form composite particles by coating the active material with an oxide solid electrolyte (e.g., LiNbO₃). Furthermore, in order to promote interface formation between the composite particles and the sulfide solid electrolyte, it has also been proposed to coat the composite particles with a sulfide solid electrolyte.

For example, Japanese Unexamined Patent Application Publication No. 2014-154407 (JP 2014-154407 A) discloses a composite active material including active material particles, composite particles, and a sulfide-based solid electrolyte. The active material particles contain at least one of a cobalt element, a nickel element, and a manganese element, and further contain a lithium element and an oxygen element. The composite particles contain an oxide-based solid electrolyte that covers all or part of the surface of the active material particles. The sulfide-based solid electrolyte further covers 76.0% or more of the surface of the composite particles. According to JP 2014-154407 A, this composite active material can reduce the reaction resistance in lithium batteries.

Japanese Unexamined Patent Application Publication No. 2020-053307 (JP 2020-053307 A) discloses an all-solid-state battery. This all-solid-state battery includes: a solid electrolyte layer containing an oxide-based solid electrolyte as a main component; a first electrode layer formed on a first main surface of the solid electrolyte layer and containing an active material serving as a cathode and an Li—La—Ti—O-based oxide; and a second electrode layer formed on a second main surface of the solid electrolyte layer and containing an active material serving as a cathode and an Li—La—Ti—O-based oxide. According to JP 2020-053307 A, this all-solid-state battery can be easily fabricated and allows flexible design of the operating voltage.

Furthermore, Japanese Unexamined Patent Application Publication No. 2024-008476 (JP 2024-008476 A) discloses an electrode material. This electrode material has a solid content concentration of 72% or more, and contains composite particles, a sulfide solid electrolyte, and a solvent. The composite particles include an active material and a fluoride solid electrolyte. The fluoride solid electrolyte covers at least part of the surface of the active material, and the sulfide solid electrolyte adheres to the composite particles. According to JP 2024-008476 A, this electrode material can reduce the rate of resistance increase after durability testing.

### SUMMARY

One method for coating active material particles with a sulfide solid electrolyte is a wet process. In the wet process, active material particles and a sulfide solid electrolyte are kneaded together with the addition of a solvent, thereby deforming at least part of the sulfide solid electrolyte and coating the active material particles with the sulfide solid electrolyte. In the wet process, when the solvent is added to change the solid-phase concentration (nonvolatile content (NV)), the shear stress of the kneaded material changes. In this regard, immediately after the solvent is added, the solid-phase concentration in the kneaded material is non-uniform. Therefore, there is a concern that mechanical load applied to a kneading device may become locally high.

Accordingly, an object of the present disclosure is to reduce mechanical load applied to a kneading device.

The present disclosure achieves the above object by the following means.

### First Aspect

A method for producing electrode composite powder includes:
(a) kneading active material particles and a sulfide solid electrolyte while adding a solvent; and
(b) after the (a), kneading the active material particles and the sulfide solid electrolyte without adding a solvent, so as to at least partially deform the sulfide solid electrolyte and coat at least part of the surface of the active material particles with the sulfide solid electrolyte.

The kneading speed in the (a) is lower than the kneading speed in the (b).

The electrode composite powder includes the active material particles and the sulfide solid electrolyte.

### Second Aspect

In the method according to the first aspect, the solvent is added in the form of a mixture containing either or both of an additional amount of the sulfide solid electrolyte and an additional amount of the active material particles.

### Third Aspect

The method according to the first or second aspect further includes alternately repeating the (a) and the (b).

### Fourth Aspect

In the method according to any one of the first to third aspects, the active material particles are pre-coated active material particles having at least part of a surface pre-coated with a solid electrolyte for coating.

### Fifth Aspect

In the method according to the fourth aspect, the solid electrolyte for coating is a fluorine-containing solid electrolyte.

### Sixth Aspect

In the method according to the fifth aspect, the solid electrolyte for coating is Li_{6-(4-x)b}(Ti₁₋ₓAlₓ)_{b}F₆, where 0<x<1 and 0<b≤1.5.

### Seventh Aspect

A method for manufacturing a battery includes:
producing electrode composite powder by the method according to any one of the first to sixth aspects; and
forming an active material layer containing the electrode composite powder.

With the above method of the present disclosure, it is possible to reduce excessive load on a kneading device when kneading active material particles and a sulfide solid electrolyte.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing the relationship between normal stress and shear stress in a plurality of kneaded materials having predetermined NVs; and

FIG. 2 is a graph showing the relationship between the NV and the slope of the shear stress.

### DETAILED DESCRIPTION OF EMBODIMENTS

### Method for Producing Electrode Composite Powder

A method for producing electrode composite powder according to the present disclosure includes:
(a) kneading active material particles and a sulfide solid electrolyte while adding a solvent; and
(b) after step (a), kneading the active material particles and the sulfide solid electrolyte without adding a solvent, so as to at least partially deform the sulfide solid electrolyte and coat at least part of the surface of the active material particles with the sulfide solid electrolyte.

The kneading speed in step (a) is lower than the kneading speed in step (b).

The electrode composite powder includes the active material particles and the sulfide solid electrolyte.

With the above method for producing electrode composite powder, it is possible to reduce excessive load on a kneading device when kneading the active material particles and the sulfide solid electrolyte.

In conventional methods, a solvent is added without kneading active material particles and a sulfide solid electrolyte, and the kneading of the active material particles and the sulfide solid electrolyte is performed after the solvent is added. In this case, the solvent is locally distributed among the active material particles and the sulfide solid electrolyte. The stress required for kneading the sulfide solid electrolyte varies depending on the solid-phase concentration (nonvolatile content), that is, the ratio of the solvent contained. Therefore, such localized distribution of the solvent may result in excessive mechanical load being applied to the kneading device.

In contrast, according to the method of the present disclosure, in step (a), a solvent is added while kneading is performed at a relatively low speed. It is therefore possible to reliably mix solid-phase components (i.e., the active material particles and the sulfide solid electrolyte) with the solvent in step (a), while reducing excessive mechanical load on the kneading device.

According to the method of the present disclosure, in step (b) that is performed after step (a), kneading is performed at a relatively high speed without adding a solvent. Therefore, it is possible to rapidly deform the sulfide solid electrolyte and coat the surface of the active material particles with the sulfide solid electrolyte, while reducing both the localized distribution of the solvent caused by its addition and the resulting excessive mechanical load on the kneading device.

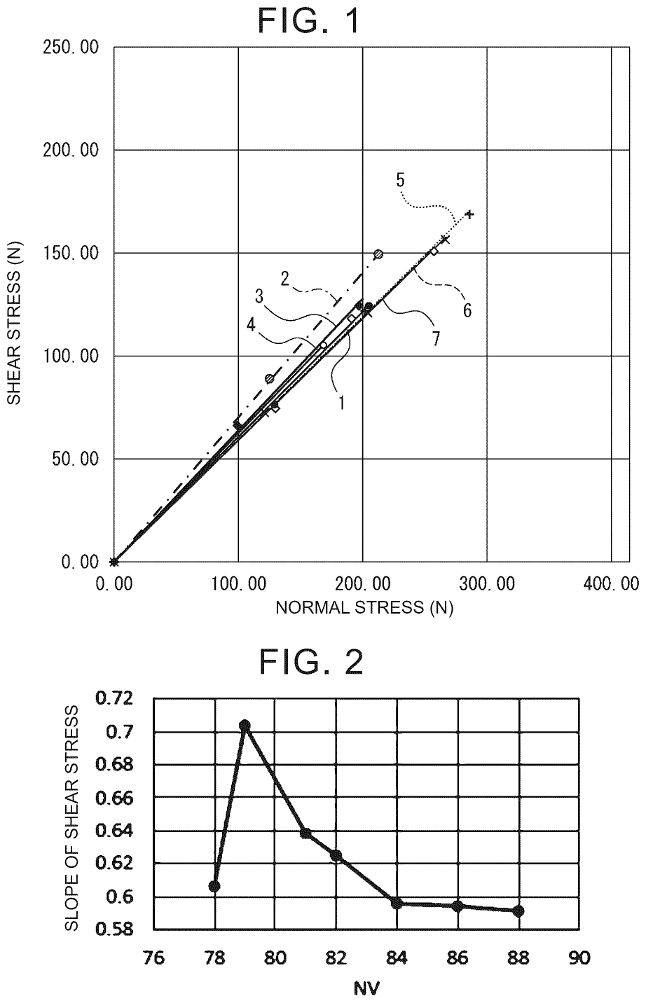

FIG. 1 shows the relationship between normal stress and shear stress in a plurality of kneaded materials having predetermined NVs. A steep slope of the shear stress indicates that the shear stress becomes large when a high stress is applied, that is, a large mechanical load is applied to the kneading device. The slope of the shear stress of the kneaded material varies depending on the NV value of the kneaded material. In the present disclosure, the slope of the shear stress refers to the magnitude of the change in shear stress with respect to a change in normal stress of the kneaded material.

FIG. 2 shows the relationship between the slope of the shear stress and the predetermined NVs in FIG. 1. In a kneaded material containing a sulfide solid electrolyte, the slope of the shear stress becomes specifically large when the NV takes a predetermined value. Therefore, when a solvent is added to the active material particles and the sulfide solid electrolyte to reduce the NV, the slope of the shear stress increases (that is, the mechanical load applied to the kneading device during kneading increases) until the NV reaches the predetermined value (until the NV reaches approximately 78.5 in the case of FIG. 2). The compositions of the samples shown in FIG. 1 are as follows.
1. A mixture of a sulfide solid electrolyte (SE) and Li(NiCoAl)O₂ coated with Li_{2.7}Ti_{0.3}Al_{0.7}F₆(LTAF-coated NCA), NV=78%
2. A mixture of SE and LTAF-coated NCA, NV=79%
3. A mixture of SE and LTAF-coated NCA, NV=81%
4. A mixture of SE and LTAF-coated NCA, NV=82%
5. A mixture of SE and LTAF-coated NCA, NV=84%
6. A mixture of SE and LTAF-coated NCA, NV=86%
7. A mixture of SE and LTAF-coated NCA, NV=88%

Hereinafter, an embodiment of the present disclosure will be described in detail. The present disclosure is not limited to the following embodiment, and various modifications may be made without departing from the scope of the present disclosure.

### Step (a)

In the method of the present disclosure, active material particles and a sulfide solid electrolyte are kneaded while adding a solvent.

In the method of the present disclosure, the solvent may be added in the form of a mixture containing either or both of an additional amount of the sulfide solid electrolyte and an additional amount of the active material particles. In this case, the mixing of the solvent with either or both of the additional sulfide solid electrolyte and the additional active material particles may be performed in advance using an ultrasonic homogenizer.

In the method of the present disclosure, the kneading speed in step (a) is lower than the kneading speed in step (b). Specifically, for example, the difference between the kneading speed in step (a) and the kneading speed in step (b) may be 5 rpm or more, 10 rpm or more, 20 rpm or more, 30 rpm or more, or 35 rpm or more, and may be 100 rpm or less, 80 rpm or less, 60 rpm or less, or 50 rpm or less. In the present disclosure, the kneading speed in step (a) may be 10 rpm or more, 20 rpm or more, or 30 rpm or more, and may be 80 rpm or less, 70 rpm or less, or 60 rpm or less.

In the method of the present disclosure, the kneading in step (a) may be performed in a low dew point environment, for example, an environment having a dew point temperature of 0° C. or lower, −30° C. or lower, −50° C. or lower, or −70° C. or lower.

In the method of the present disclosure, the kneading in step (a) is performed under low-solvent conditions. In the method of the present disclosure, any kneading device can be used as long as such kneading under low-solvent conditions is possible. For example, a planetary centrifugal mixer may be used as a kneading device. The method of the present disclosure can be performed using a planetary mixer etc. as the kneading device.

In the method of the present disclosure, the kneading time in step (a) can be selected as appropriate within a range that can reduce both localized distribution of the solvent caused by its addition and the resulting excessive mechanical load on the kneading device.

### Step (b)

In the method of the present disclosure, the active material particles and the sulfide solid electrolyte are then kneaded together without adding a solvent, so as to at least partially deform the sulfide solid electrolyte and coat at least part of the surface of the active material particles with the sulfide solid electrolyte.

In the present disclosure, the kneading speed in step (b) may be 50 rpm or more, 60 rpm or more, or 70 rpm or more, and may be 110 rpm or less, 100 rpm or less, or 90 rpm or less.

In the method of the present disclosure, the kneading time in step (b) can be selected as appropriate within a range that allows sufficient kneading of the sulfide solid electrolyte and the active material particles.

In the method of the present disclosure, the kneading in step (b) may be performed in a low dew point environment, for example, an environment having a dew point temperature of 0° C. or lower, −30° C. or lower, −50° C. or lower, or −70° C. or lower.

In the method of the present disclosure, the kneading in step (b) can be performed using a planetary mixer etc. as the kneading device.

In the method of the present disclosure, steps (a), (b) may be alternately repeated. This makes it possible to add the solvent in multiple parts. If the solvent is not added in multiple parts and the entire amount to be added is introduced at once, the kneaded material may become liquefied. Once the kneaded material becomes liquefied, the kneading may not be maintained, and the desired coating process may not be successfully completed.

### Method for Manufacturing Battery

A method for manufacturing a battery according to the present disclosure includes:
producing electrode composite powder by the method described herein; and
forming an active material layer containing the electrode composite powder.

The active material layer of the battery manufactured by the method of the present disclosure may be provided by a composite slurry containing the electrode composite powder and a dispersion medium. The active material layer may be formed by applying the composite slurry to a substrate and then drying to remove the dispersion medium.

### Components

Hereinafter, the components used in the method of the present disclosure will be described.

### Electrode Composite Powder

In the present disclosure, the electrode composite powder includes the active material particles and the sulfide solid electrolyte.

### Active Material Particles

In the present disclosure, the active material particles are contained in the electrode composite powder and are coated with the sulfide solid electrolyte by the method of the present disclosure.

In the present disclosure, the “active material particles” may be either a “cathode active material” or an “anode active material.”

The active material particles are not particularly limited, and may be pre-coated active material particles including a coating layer made of a solid electrolyte for coating. The coating layer is a layer that contains a substance having lithium-ion conduction properties and low reactivity with the active material particles and the solid electrolyte and capable of maintaining its form as a coating layer without flowing even when in contact with the active material particles or the solid electrolyte. Specific examples of the solid electrolyte for coating include, but are not limited to, LiNbO₃, Li₄Ti₅O₁₂, Li₃PO₄, and Li_{2.7}Ti_{0.3}Al_{0.7}F₆. In particular, when the solid electrolyte for coating is a fluorine-containing solid electrolyte such as an LTAF electrolyte (Li_{6-(4-x)b}(Ti₁₋ₓAlₓ)_{b}F₆ (where 0<x<1 and 0<b≤1.5)), for example, Li_{2.7}Ti_{0.3}Al_{0.7}F₆, the solvent and the pre-coated active material particles are not easily mixable. As a result, the solvent becomes locally distributed, and an excessive mechanical load is more likely to be applied to the kneading device. Therefore, the method of the present disclosure can be effectively used.

### Cathode Active Material

The cathode active material is not particularly limited. Examples of the cathode active material include, but are not limited to, lithium cobalt oxide (LiCoO₂), lithium nickel oxide (LiNiO₂), lithium manganese oxide (LiMn₂O₄), lithium nickel cobalt manganese oxide (NCM:LiCO_{1/3}Ni_{1/3}Mn_{1/2}O₂), lithium nickel cobalt aluminum oxide (LiNi_{0.8}(CoAl)_{0.2}O₂), and a hetero-element-substituted Li—Mn spinel having a composition represented by Li₁₊ₓMn_{2-x-y}M_{y}O₄ (where M is one or more metal elements selected from Al, Mg, Co, Fe, Ni, and Zn).

### Active Material

The active material serves as the core of the electrode composite powder. The active material is in the form of particles. The active material may be, for example, secondary particles. The secondary particles are aggregates of primary particles. The D₅₀ of the secondary particles may be, for example, from 1 μm to 30 μm, from 3 μm to 20 μm, or from 5 μm to 15 μm. The average Feret diameter of the primary particles may be, for example, 0.01 μm to 3 μm.

The active material may have any shape. For example, the active material may be spherical, ellipsoidal, flaky, or fibrous. The active material may be solid particles or hollow particles. The average particle size D₅₀ refers to the particle size (median particle size) at 50% of the volume-based cumulative particle size distribution as measured by a laser diffraction and scattering method.

### Anode Active Material

The anode active material is not particularly limited, and may be metallic lithium or a material capable of intercalating and deintercalating metal ions such as lithium ions. Examples of the material capable of intercalating and deintercalating metal ions such as lithium ions include, but are not limited to, alloy-based anode active materials, carbon materials, and lithium titanate (Li₄Ti₅O₁₂).

The alloy-based anode active materials are not particularly limited, and examples thereof include Si-alloy-based anode active materials and Sn-alloy-based anode active materials. Examples of the Si-alloy-based anode active materials include silicon, silicon oxides, silicon carbides, silicon nitrides, and solid solutions thereof. The Si-alloy-based anode active materials may also contain metal elements other than silicon, such as Fe, Co, Sb, Bi, Pb, Ni, Cu, Zn, Ge, In, Sn, and Ti. Examples of the Sn-alloy-based anode active materials include tin, tin oxides, tin nitrides, and solid solutions thereof. The Sn-alloy-based anode active materials may also contain metal elements other than tin, such as Fe, Co, Sb, Bi, Pb, Ni, Cu, Zn, Ge, In, Ti, and Si.

The carbon materials are not particularly limited, and examples thereof include hard carbon, soft carbon, and graphite.

The anode active material is in the form of particles. The anode active material may be in the form of primary particles or secondary particles formed by aggregation of a plurality of primary particles. The average particle size D₅₀ of the anode active material may be, for example, 1 nm or more, 5 nm or more, or 10 nm or more, and may be 500 μm or less, 100 μm or less, 50 μm or less, or 30 μm or less. The average particle size D₅₀ refers to the particle size (median particle size) at 50% of the volume-based cumulative particle size distribution as measured by a laser diffraction and scattering method.

### Sulfide Solid Electrolyte

In the present disclosure, the sulfide solid electrolyte is contained in the electrode composite powder.

The sulfide solid electrolyte adheres to the surface of the active material particles together with the solvent. The sulfide solid electrolyte may coat the surface of the active material particles. The sulfide solid electrolyte is in the form of particles. The D₅₀ of the sulfide solid electrolyte may be, for example, from 0.01 μm to 1 μm or from 0.1 μm to 0.9 μm. The blending amount of the sulfide solid electrolyte may be, for example, from 0.1 parts by mass to 20 parts by mass, or from 0.5 parts by mass to 15 parts by mass, per 100 parts by mass of the active material.

Examples of the sulfide solid electrolyte include, but are not limited to, sulfide-based amorphous solid electrolytes, sulfide-based crystalline solid electrolytes, and argyrodite-type solid electrolytes. Examples of the sulfide solid electrolytes include, but are not limited to, Li₂S—P₂S₅-based electrolytes (e.g., Li₇P₃S₁₁, Li₃PS₄, and LisP₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, Li₇₋ₓPS₆₋ₓClₓ, and combinations thereof.

The sulfide solid electrolyte may be a glass or a crystallized glass (glass ceramic).

### Solvent

In the present disclosure, the solvent is added while kneading the active material particles and the sulfide solid electrolyte.

The solvent is a liquid. The solvent may promote adhesion between the active material particles and the sulfide solid electrolyte during kneading. The solvent may function as a dispersion medium in a slurry. The solvent may contain any component. The solvent may contain, for example, at least one selected from the group consisting of aromatic hydrocarbons, esters, alcohols, ketones, and lactams. The solvent may contain, for example, at least one selected from the group consisting of tetralin (1,2,3,4-tetrahydronaphthalene, THN), butyl butyrate, heptane, and N-methyl-2-pyrrolidone (NMP).

Butyl butyrate is expected to be less likely to degrade the sulfide solid electrolyte than, for example, NMP. THN is expected to be even less likely to degrade the sulfide solid electrolyte than, for example, butyl butyrate and NMP. A solvent containing THN is expected to reduce, for example, the initial resistance.

The present disclosure will be described in more detail below with reference to examples. However, these examples are not intended to limit the scope of the disclosure.

Electrode composite powder was produced according to the production method of the embodiment, and the average and maximum power consumption of the device during the production were evaluated.

### Preparation of Pre-Coated Active Material Particles

Li(NiCoAl)O₂ was prepared as an active material. This active material may be hereinafter abbreviated as “NCA.”

A fluoride solid electrolyte as a solid electrolyte for coating was synthesized by mixing LiF, TiF₄, and AlF₃ in a planetary ball mill. The fluoride solid electrolyte had a composition represented by Li_{2.7}Ti_{0.3}Al_{0.7}F₆. This fluoride solid electrolyte may be hereinafter abbreviated as “LTAF.”

A “Nobilta NOB-MINI” (manufactured by Hosokawa Micron Corporation) was used as a device for pre-coating the active material particles. In this device, 48.7 parts by mass of NCA and 1.3 parts by mass of LTAF were kneaded together to form pre-coated active material particles. The operating conditions of the device are as follows.
Power: 12 W per gram of material
Rotational speed: 6000 rpm
Processing time: 30 minutes

### Other Materials

For the examples of the present disclosure, the following materials were prepared.
Sulfide solid electrolyte: Li₂S—P₂S₅ (glass ceramic)
Solvent: THN
“Li₂S—P₂S₅” may be hereinafter abbreviated as “LPS.”

### Example 1

The subsequent operations were conducted in an environment where the dew point was controlled to −70° C. or lower. An ultrasonic homogenizer was used as a dispersion device. A dispersion was prepared by dispersing the sulfide solid electrolyte in the solvent using the ultrasonic homogenizer.

A planetary mixer was used as a kneading device. The pre-coated active material particles prepared as described above were fed into the kneading device.

Electrode composite powder was produced by performing “kneading” and “solvent addition during kneading” in the following order of steps (0) to (4). In the “solvent addition during kneading,” the solvent was added with a dropper while kneading the pre-coated active material particles and the sulfide solid electrolyte together. An evaluation sample of Example 1, that is, electrode composite powder in which the pre-coated active material particles are coated with the sulfide solid electrolyte, was thus obtained.
(0) Preparation for kneading (supplying the dispersion to the pre-coated active material particles): no kneading
(1) Kneading: low kneading speed
(2) Solvent addition during kneading: low kneading speed
(3) Kneading: medium kneading speed
(4) Kneading: high kneading speed

### Example 2

An evaluation sample of Example 2, namely electrode composite powder, was obtained in the same manner as in Example 1, except that the LTAF in Example 1 was replaced with LiNbO₃.

### Example 3

An evaluation sample of Example 3, namely electrode composite powder, was obtained in the same manner as in Example 1, except that the above procedure was replaced with the following procedure.
(0) Preparation for kneading (supplying the dispersion to the pre-coated active material particles): no kneading
(1) Kneading: low kneading speed
(2) Solvent addition during kneading: low kneading speed
(3) Kneading: medium kneading speed
(4) Solvent addition during kneading: low kneading speed
(5) Kneading: medium kneading speed
(6) Kneading: high kneading speed

### Example 4

An evaluation sample of Example 4, that is, electrode composite powder, was obtained in the same manner as in Example 1, except that the above procedure was replaced with the following procedure.
(0) Preparation for kneading (supplying the dispersion to the pre-coated active material particles): low kneading speed
(1) Kneading: low kneading speed
(2) Solvent addition during kneading: low kneading speed
(3) Kneading: medium kneading speed
(4) Kneading: high kneading speed

### Comparative Example 1

The subsequent operations were conducted in an environment where the dew point was controlled to −70° C. or lower. An ultrasonic homogenizer was used as a dispersion device. A dispersion was prepared by dispersing 98.4 parts by mass of the sulfide solid electrolyte in 229.6 parts by mass of the solvent using the ultrasonic homogenizer.

A planetary mixer was used as a kneading device. Specifically, 1000 parts by mass of the pre-coated active material particles prepared as described above were fed into the kneading device.

Electrode composite powder was produced by performing “kneading” and “solvent addition” in the following order of steps (0) to (3). When kneading was performed at 100 rpm for 10 minutes in “(3) Kneading” below, the kneaded material became liquefied. Therefore, kneading could not be performed, and the pre-coated active material particles could not be coated with the sulfide solid electrolyte.
(0) Preparation for kneading (supplying the dispersion to the pre-coated active material particles): no kneading
(1) Kneading: kneading speed of 70 rpm
(2) Solvent addition: no kneading
(3) Kneading: kneading speed of 100 rpm

### Comparative Example 2

An evaluation sample of Comparative Example 2, namely electrode composite powder, was obtained in the same manner as in Comparative Example 1, except that the above procedure was replaced with the following procedure.
(0) Preparation for kneading (supplying the dispersion to the pre-coated active material particles): no kneading
(1) Kneading: kneading speed of 70 rpm
(2) Solvent addition: no kneading
(3) Kneading: kneading speed of 100 rpm
(4) Solvent addition: no kneading
(5) Kneading: kneading speed of 100 rpm
(6) Solvent addition: no kneading
(7) Kneading: kneading speed of 100 rpm

### Evaluation

Table 1 shows the average and maximum power consumption of the device when the electrode composite powders were produced by the methods described in Examples 1 to 4 and Comparative Examples 1, 2. As is apparent from Table 1, Examples 1 to 4 had lower average and maximum power consumption compared to Comparative Examples 1, 2. This indicates that the mechanical load on the device was smaller. Accordingly, by using the method of the present disclosure, the electrode composite powder was able to be produced by kneading the pre-coated active material particles with the sulfide solid electrolyte while reducing excessive load on the device.

TABLE 1

| | Average Power | Maximum Power |
|---|---|---|
| | Consumption (W) | Consumption (W) |
| Example 1 | 80 | 90 |
| Example 2 | 73 | 78 |
| Example 3 | 79 | 85 |
| Example 4 | 79 | 88 |
| Comparative Example 1 | 121 | 134 |
| Comparative Example 2 | 104 | 116 |

What is claimed is:

1. A method for producing electrode composite powder, the method comprising:
(a) kneading active material particles and a sulfide solid electrolyte while adding a solvent; and
(b) after the (a), kneading the active material particles and the sulfide solid electrolyte without adding a solvent, so as to at least partially deform the sulfide solid electrolyte and coat at least part of a surface of the active material particles with the sulfide solid electrolyte, wherein:
a kneading speed in the (a) is lower than a kneading speed in the (b); and
the electrode composite powder includes the active material particles and the sulfide solid electrolyte.

2. The method according to claim 1, wherein the solvent is added in a form of a mixture containing either or both of an additional amount of the sulfide solid electrolyte and an additional amount of the active material particles.

3. The method according to claim 1, further comprising alternately repeating the (a) and the (b).

4. The method according to claim 1, wherein the active material particles are pre-coated active material particles having at least part of a surface pre-coated with a solid electrolyte for coating.

5. The method according to claim 4, wherein the solid electrolyte for coating is a fluorine-containing solid electrolyte.

6. The method according to claim 5, wherein the solid electrolyte for coating is Li_{6-(4-x)b}(Ti₁₋ₓAlₓ)_{b}F₆, where 0<x<1 and 0<b≤1.5.

7. A method for manufacturing a battery, the method comprising:
producing electrode composite powder by the method according to claim 1; and
forming an active material layer containing the electrode composite powder.
